(19) United States
(12) Patent Application Publication
(10) Pub. No.: US 2024/0346080 A1
(43) Pub. Date: Oct. 17, 2024

(54) SYSTEMS AND METHODS FOR SUGGESTING QUERIES USING A GRAPH

(71) Applicant: Spotify AB, Stockholm (SE)

(72) Inventors: Enrico PALUMBO, Torino (IT); Rui André Augusto FERREIRA, London (GB); Andreas DAMIANOU, Cambridge (GB); Alice WANG, New York, NY (US); Ghazal FAZELNIA, New York, NY (US); Praveen Chandar RAVICHANDRAN, Alexandria, VA (US); Claudia HAUFF, Delft (NL); Hugues BOUCHARD, Barcelona (ES); Humberto Jesús CORONA PAMPIN, Amsterdam (NL)

(21) Appl. No.: 18/300,295

(22) Filed: Apr. 13, 2023

(51) Int. Cl. G06F 16/9032; G06F 16/901; G06F 16/908

(52) U.S. Cl. CPC G06F 16/90324; G06F 16/9024; G06F 16/908

(57) ABSTRACT

An electronic device, for a search session, receives one or more user-input search queries and determines, based on interactions with each user-input search query, whether the search session satisfies success criteria. The electronic device generates a graph that includes, for a plurality of search sessions that satisfy the success criteria: a first set of nodes, each node in the first set of nodes corresponding to a respective search query of the plurality of search queries in a respective search session, and a second set of nodes, each node in the second set of nodes corresponding to a respective content item selected from a respective search query of the plurality of search queries in a respective search session. The electronic device converts the first and the second set of nodes of the graph to a vector space and provides a recommendation based on the nodes in the vector space.

### TECHNICAL FIELD

The disclosed embodiments relate generally to media provider systems, and, in particular, to generating a graph based on historical search sessions that is used to recommend search queries for a user.

### BACKGROUND

Recent years have shown a remarkable growth in consumption of digital goods such as digital music, movies, books, and podcasts, among many others. The overwhelmingly large number of these goods often makes navigation and discovery of new digital goods an extremely difficult task. To cope with the constantly growing complexity of navigating the large number of goods, users are enabled to input search criteria, via text and voice commands, to search for and access media items. Media content providers are able to provide personalized recommendations for content based on the input search criteria.

### SUMMARY

When a user inputs a search query that includes search criteria, a media content provider is enabled to provide search results of content items that match the search criteria. In some embodiments, it is beneficial to also provide the user with recommended related search queries, such as search terms that share metadata or are otherwise related to the user-input search query. The recommended related search queries help the user find or explore related content based on previous queries searched by users of the media-providing service.

In the disclosed embodiments, systems and methods are provided for recommending one or more related search terms (e.g., related queries) based on a user query. The system uses a multi-step process, including building a graph that includes the query and additional information, such as other metadata associated with the query and/or other search terms input during the search session. The graph includes edges between, e.g., queries and media items, that are based on a user selecting the media item after entering the query and also includes edges between, e.g., media items and descriptors, topics, etc., which are based on metadata. Nodes of the graph are translated into vectors in a vector space, using any of a variety of known techniques, and search terms are recommended using the vectors in the vector space (e.g., by selecting nearest neighbors).

To that end, in accordance with some embodiments, a method is provided. The method includes, for a search session: receiving one or more user-input search queries and determining, based on interactions with each user-input search query of the one or more user-input search queries, whether the search session satisfies success criteria. The method further includes generating a graph that includes, for a plurality of search sessions that satisfy the success criteria: a first set of nodes, each node in the first set of nodes corresponding to a respective search query of the plurality of search queries in a respective search session; and a second set of nodes, each node in the second set of nodes corresponding to a respective content item selected from a respective search query of the plurality of search queries in a respective search session. The method includes converting the first set of nodes and the second set of nodes of the graph to a vector space; and providing a recommendation based on the nodes in the vector space.

In accordance with some embodiments, an electronic device is provided. The electronic device includes one or more processors and memory storing one or more programs. The one or more programs include instructions for performing any of the methods described herein.

In accordance with some embodiments, a non-transitory computer-readable storage medium is provided. The non-transitory computer-readable storage medium stores one or more programs for execution by an electronic device with one or more processors. The one or more programs comprises instructions for performing any of the methods described herein.

Thus, systems are provided with improved methods for recommending search queries using a graph.

### BRIEF DESCRIPTION OF THE DRAWINGS

The embodiments disclosed herein are illustrated by way of example, and not by way of limitation, in the figures of the accompanying drawings. Like reference numerals refer to corresponding parts throughout the drawings and specification.

FIG. 1 is a block diagram illustrating a media content delivery system, in accordance with some embodiments.

FIG. 2 is a block diagram illustrating an electronic device, in accordance with some embodiments.

FIG. 3 is a block diagram illustrating a media content server, in accordance with some embodiments.

FIGS. 4A-4B are block diagrams illustrating generating a graph and converting the graph to vector space, in accordance with some embodiments.

FIG. 5 is a block diagram illustrating user interfaces for displaying recommendations in a search user interface, in accordance with some embodiments.

FIGS. 6A-6B are flow diagrams illustrating a method of providing a recommendation using vectors in a vector space that are generated from a graph, in accordance with some embodiments.

### DETAILED DESCRIPTION

Reference will now be made to embodiments, examples of which are illustrated in the accompanying drawings. In the following description, numerous specific details are set forth in order to provide an understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are used only to distinguish one element from another. For example, a first electronic device could be termed a second electronic device, and, similarly, a second electronic device could be termed a first electronic device, without departing from the scope of the various described embodiments. The first electronic device and the second electronic device are both electronic devices, but they are not the same electronic device.

The terminology used in the description of the various embodiments described herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

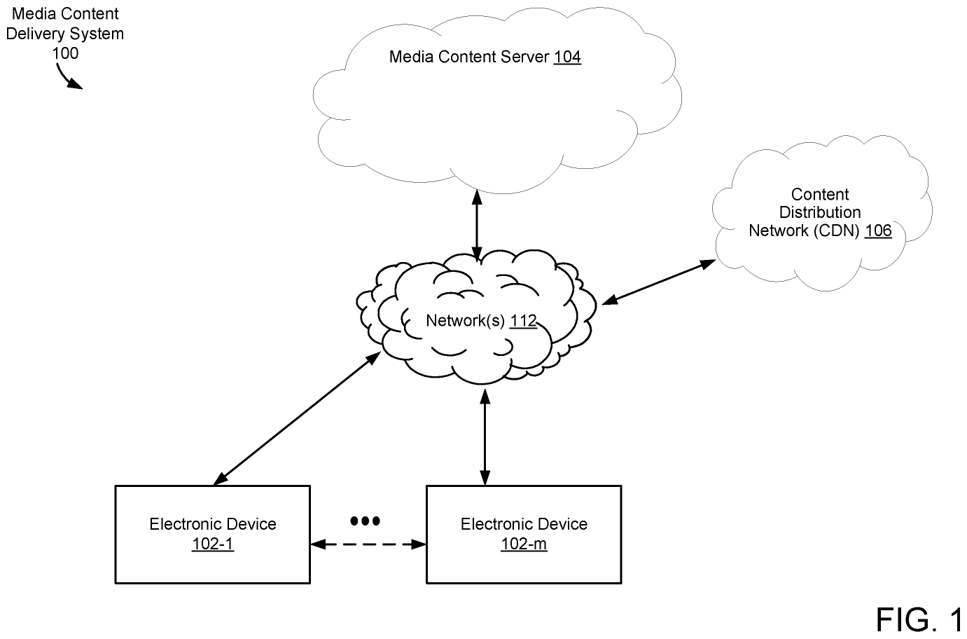

FIG. 1 is a block diagram illustrating a media content delivery system 100, in accordance with some embodiments. The media content delivery system 100 includes one or more electronic devices 102 (e.g., electronic device 102-1 to electronic device 102-m, where m is an integer greater than one), one or more media content servers 104, and/or one or more content distribution networks (CDNs) 106. The one or more media content servers 104 are associated with (e.g., at least partially compose) a media-providing service. The one or more CDNs 106 store and/or provide one or more content items (e.g., to electronic devices 102). In some embodiments, the CDNs 106 are included in the media content servers 104. One or more networks 112 communicably couple the components of the media content delivery system 100. In some embodiments, the one or more networks 112 include public communication networks, private communication networks, or a combination of both public and private communication networks. For example, the one or more networks 112 can be any network (or combination of networks) such as the Internet, other wide area networks (WAN), local area networks (LAN), virtual private networks (VPN), metropolitan area networks (MAN), peer-to-peer networks, and/or ad-hoc connections.

In some embodiments, an electronic device 102 is associated with one or more users. In some embodiments, an electronic device 102 is a personal computer, mobile electronic device, wearable computing device, laptop computer, tablet computer, mobile phone, feature phone, smart phone, an infotainment system, digital media player, a speaker, television (TV), and/or any other electronic device capable of presenting media content (e.g., controlling playback of media items, such as music tracks, podcasts, videos, etc.). Electronic devices 102 may connect to each other wirelessly and/or through a wired connection (e.g., directly through an interface, such as an HDMI interface). In some embodiments, electronic devices 102-1 and 102-m are the same type of device (e.g., electronic device 102-1 and electronic device 102-m are both speakers). Alternatively, electronic device 102-1 and electronic device 102-m include two or more different types of devices.

In some embodiments, electronic devices 102-1 and 102-m send and receive media-control information through network(s) 112. For example, electronic devices 102-1 and 102-m send media control requests (e.g., requests to play music, podcasts, movies, videos, or other media items, or playlists thereof) to media content server 104 through network(s) 112. Additionally, electronic devices 102-1 and 102-m, in some embodiments, also send indications of media content items to media content server 104 through network(s) 112. In some embodiments, the media content items are uploaded to electronic devices 102-1 and 102-m before the electronic devices forward the media content items to media content server 104.

In some embodiments, electronic device 102-1 communicates directly with electronic device 102-m (e.g., as illustrated by the dotted-line arrow), or any other electronic device 102. As illustrated in FIG. 1, electronic device 102-1 is able to communicate directly (e.g., through a wired connection and/or through a short-range wireless signal, such as those associated with personal-area-network (e.g., BLUETOOTH/BLE) communication technologies, radio-frequency-based near-field communication technologies, infrared communication technologies, etc.) with electronic device 102-m. In some embodiments, electronic device 102-1 communicates with electronic device 102-m through network(s) 112. In some embodiments, electronic device 102-1 uses the direct connection with electronic device 102-m to stream content (e.g., data for media items) for playback on the electronic device 102-m.

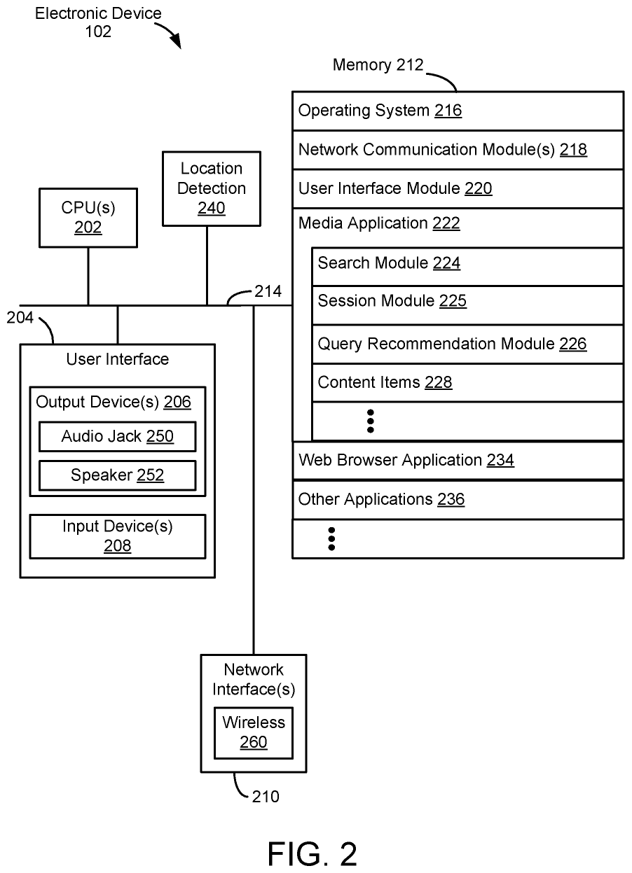

In some embodiments, electronic device 102-1 and/or electronic device 102-m include a media application 222 (FIG. 2) that allows a respective user of the respective electronic device to upload (e.g., to media content server 104), browse, request (e.g., for playback at the electronic device 102), and/or present media content (e.g., control playback of music tracks, playlists, videos, etc.). In some embodiments, one or more media content items are stored locally by an electronic device 102 (e.g., in memory 212 of the electronic device 102, FIG. 2). In some embodiments, one or more media content items are received by an electronic device 102 in a data stream (e.g., from the CDN 106 and/or from the media content server 104). The electronic device(s) 102 are capable of receiving media content (e.g., from the CDN 106) and presenting the received media content. For example, electronic device 102-1 may be a component of a network-connected audio/video system (e.g., a home entertainment system, a radio/alarm clock with a digital display, or an infotainment system of a vehicle). In some embodiments, the CDN 106 sends media content to the electronic device(s) 102.

In some embodiments, the CDN 106 stores and provides media content (e.g., media content requested by the media application 222 of electronic device 102) to electronic device 102 via the network(s) 112. Content (also referred to herein as “media items,” “media content items,” and “content items”) is received, stored, and/or served by the CDN 106. In some embodiments, content includes audio (e.g., music, spoken word, podcasts, audiobooks, etc.), video (e.g., short-form videos, music videos, television shows, movies, clips, previews, etc.), text (e.g., articles, blog posts, emails, etc.), image data (e.g., image files, photographs, drawings, renderings, etc.), games (e.g., 2-or 3-dimensional graphics-based computer games, etc.), or any combination of content types (e.g., web pages that include any combination of the foregoing types of content or other content not explicitly listed). In some embodiments, content includes one or more audio media items (also referred to herein as “audio items,” “tracks,” and/or “audio tracks”).

In some embodiments, media content server 104 receives media requests (e.g., commands) from electronic devices 102. In some embodiments, media content server 104 includes a voice API, a connect API, and/or key service. In some embodiments, media content server 104 validates (e.g., using key service) electronic devices 102 by exchanging one or more keys (e.g., tokens) with electronic device(s) 102.

In some embodiments, media content server 104 and/or CDN 106 stores one or more playlists (e.g., information indicating a set of media content items). For example, a playlist is a set of media content items defined by a user and/or defined by an editor associated with a media-providing service. The description of the media content server 104 as a “server” is intended as a functional description of the devices, systems, processor cores, and/or other components that provide the functionality attributed to the media content server 104. It will be understood that the media content server 104 may be a single server computer. or may be multiple server computers. Moreover, the media content server 104 may be coupled to CDN 106 and/or other servers and/or server systems, or other devices, such as other client devices, databases, content delivery networks (e.g., peer-to-peer networks), network caches, and the like. In some embodiments, the media content server 104 is implemented by multiple computing devices working together to perform the actions of a server system (e.g., cloud computing).

FIG. 2 is a block diagram illustrating an electronic device 102 (e.g., electronic device 102-1 and/or electronic device 102-m, FIG. 1), in accordance with some embodiments. The electronic device 102 includes one or more central processing units (CPU(s), i.e., processors or cores) 202, one or more network (or other communications) interfaces 210, memory 212, and one or more communication buses 214 for interconnecting these components. The communication buses 214 optionally include circuitry (sometimes called a chipset) that interconnects and controls communications between system components.

In some embodiments, the electronic device 102 includes a user interface 204. including output device(s) 206 and/or input device(s) 208. In some embodiments, the input devices 208 include a keyboard, mouse, or track pad. Alternatively, or in addition, in some embodiments, the user interface 204 includes a display device that includes a touch-sensitive surface, in which case the display device is a touch-sensitive display. In electronic devices that have a touch-sensitive display, a physical keyboard is optional (e.g., a soft keyboard may be displayed when keyboard entry is needed). In some embodiments, the output devices (e.g., output device(s) 206) include a speaker 252 (e.g., speakerphone device) and/or an audio jack 250 (or other physical output connection port) for connecting to speakers, earphones, headphones, or other external listening devices. Furthermore, some electronic devices 102 use a microphone and voice recognition device to supplement or replace the keyboard. Optionally, the electronic device 102 includes an audio input device (e.g., a microphone) to capture audio (e.g., speech from a user).

Optionally, the electronic device 102 includes a location-detection device 240, such as a global navigation satellite system (GNSS) (e.g., GPS (global positioning system), GLONASS, Galileo, BeiDou) or other geo-location receiver, and/or location-detection software for determining the location of the electronic device 102 (e.g., module for finding a position of the electronic device 102 using trilateration of measured signal strengths for nearby devices).

In some embodiments, the one or more network interfaces 210 include wireless and/or wired interfaces for receiving data from and/or transmitting data to other electronic devices 102, a media content server 104, a CDN 106, and/or other devices or systems. In some embodiments, data communications are carried out using any of a variety of custom or standard wireless protocols (e.g., NFC, RFID, IEEE 802.15.4, Wi-Fi, ZigBee, 6LoWPAN, Thread, Z-Wave, Bluetooth, ISA100.11a, WirelessHART, MiWi, etc.). Furthermore, in some embodiments, data communications are carried out using any of a variety of custom or standard wired protocols (e.g., USB, Firewire, Ethernet, etc.). For example, the one or more network interfaces 210 include a wireless interface 260 for enabling wireless data communications with other electronic devices 102, media presentations systems, and/or or other wireless (e.g., Bluetooth-compatible) devices (e.g., for streaming audio data to the media presentations system of an automobile). Furthermore, in some embodiments, the wireless interface 260 (or a different communications interface of the one or more network interfaces 210) enables data communications with other WLAN-compatible devices (e.g., a media presentations system) and/or the media content server 104 (via the one or more network(s) 112, FIG. 1).

In some embodiments, electronic device 102 includes one or more sensors including, but not limited to, accelerometers, gyroscopes, compasses, magnetometer, light sensors, near field communication transceivers, barometers, humidity sensors, temperature sensors, proximity sensors, range finders, and/or other sensors/devices for sensing and measuring various environmental conditions.

Memory 212 includes high-speed random-access memory, such as DRAM, SRAM, DDR RAM, or other random-access solid-state memory devices; and may include non-volatile memory, such as one or more magnetic disk storage devices, optical disk storage devices, flash memory devices, or other non-volatile solid-state storage devices. Memory 212 may optionally include one or more storage devices remotely located from the CPU(s) 202. Memory 212, or alternately, the non-volatile memory solid-state storage devices within memory 212, includes a non-transitory computer-readable storage medium. In some embodiments, memory 212 or the non-transitory computer-readable storage medium of memory 212 stores the following programs, modules, and data structures, or a subset or superset thereof:
an operating system 216 that includes procedures for handling various basic system services and for performing hardware-dependent tasks;
network communication module(s) 218 for connecting the client device 102 to other computing devices (e.g., media presentation system(s), media content server 104, and/or other client devices) via the one or more network interface(s) 210 (wired or wireless) connected to one or more network(s) 112;
a user interface module 220 that receives commands and/or inputs from a user via the user interface 204 (e.g., from the input devices 208) and provides outputs for playback and/or display on the user interface 204 (e.g., the output devices 206);
a media application 222 (e.g., an application for accessing a media-providing service of a media content provider associated with media content server 104) for uploading, browsing, receiving, processing, presenting, and/or requesting playback of media (e.g., media items). In some embodiments, media application 222 includes a media player, a streaming media application, and/or any other appropriate application or component of an application. In some embodiments, media application 222 is used to monitor, store, and/or transmit (e.g., to media content server 104) data associated with user behavior. In some embodiments, media application 222 also includes the following modules (or sets of instructions), or a subset or superset thereof:
   a search module 224 for receiving a user-input search query and/or for retrieving media items that match the search query (e.g., locally, or from a server of the media-content provider);
   a session module 225 for determining (e.g., using a heuristic) a search session, including identifying one or more user-entered search queries that correspond to a same search session. In some embodiments, session module 225 further determines whether a search session is a successful or an unsuccessful search session based on user interactions with the search results presented for respective queries in the search session;
   a query recommender module 226 for identifying and/or displaying recommended queries (e.g., including queries corresponding to media items, topics, or other search terms) to include in a search user interface;
   a content items module 228 for storing media items, including audio items such as podcasts and songs, for playback and/or for forwarding requests for media content items to the media content server;
a web browser application 234 for accessing, viewing, and interacting with web sites; and
other applications 236, such as applications for word processing, calendaring, mapping, weather, stocks, time keeping, virtual digital assistant, presenting, number crunching (spreadsheets), drawing, instant messaging, e-mail, telephony, video conferencing, photo management, video management, a digital music player, a digital video player, 2D gaming, 3D (e.g., virtual reality) gaming, electronic book reader, and/or workout support.

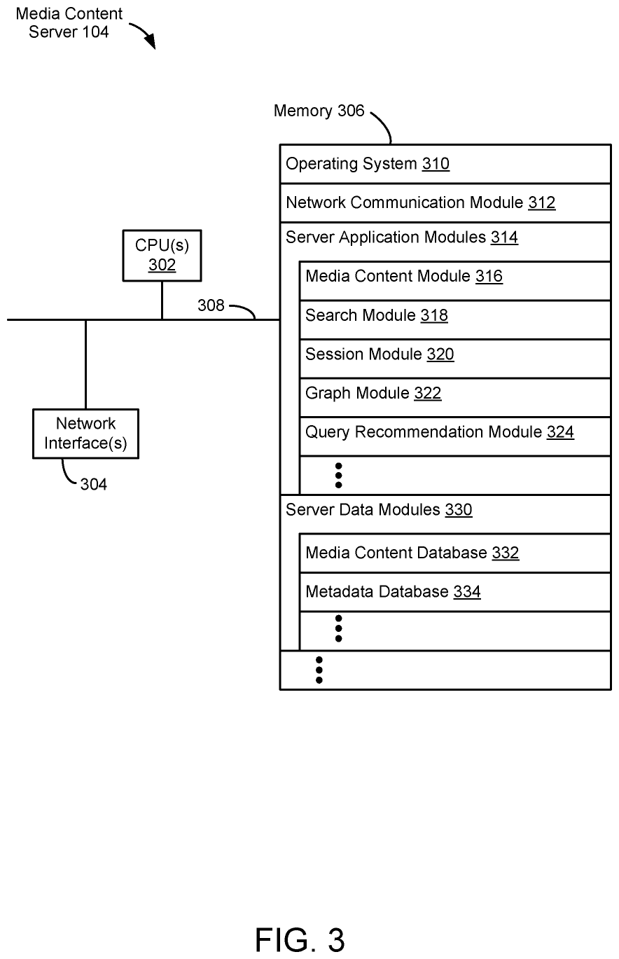

FIG. 3 is a block diagram illustrating a media content server 104, in accordance with some embodiments. The media content server 104 typically includes one or more central processing units/cores (CPUs) 302, one or more network interfaces 304, memory 306, and one or more communication buses 308 for interconnecting these components.

Memory 306 includes high-speed random access memory, such as DRAM, SRAM, DDR RAM, or other random access solid-state memory devices; and may include non-volatile memory, such as one or more magnetic disk storage devices, optical disk storage devices, flash memory devices, or other non-volatile solid-state storage devices. Memory 306 optionally includes one or more storage devices remotely located from one or more CPUs 302. Memory 306, or, alternatively, the non-volatile solid-state memory device(s) within memory 306, includes a non-transitory computer-readable storage medium. In some embodiments, memory 306, or the non-transitory computer-readable storage medium of memory 306, stores the following programs, modules and data structures, or a subset or superset thereof:
an operating system 310 that includes procedures for handling various basic system services and for performing hardware-dependent tasks;
a network communication module 312 that is used for connecting the media content server 104 to other computing devices via one or more network interfaces 304 (wired or wireless) connected to one or more networks 112;
one or more server application modules 314 for performing various functions with respect to providing and managing a content service, the server application modules 314 including, but not limited to, one or more of:
   a media content module 316 for storing one or more media content items and/or sending (e.g., streaming), to the electronic device, one or more requested media content item(s);
   a search module 318 for receiving, in real-time, from electronic device 102, a user-input search query and/or for retrieving media items that match the search query;
   a session module 320 for determining (e.g., using a heuristic) a search session, including identifying one or more search queries that correspond to a same search session. In some embodiments, session module 225 further determines whether a search session is a successful or an unsuccessful search session based on user interactions with the search results presented for respective queries in the search session;
   a graph module 322 for generating a graph that includes nodes corresponding to queries and/or documents (e.g., media content items) from one or more search sessions, and for converting the graph to a vector space (e.g., that includes nodes corresponding to search queries, documents, and/or metadata associated with documents);
   a query recommendation module 324 for identifying one or more queries that are related to a search query, input at electronic device 102, and for providing, for display, the identified queries as recommendations for the user of the electronic device 102.
one or more server data module(s) 330 for handling the storage of and/or access to media items and/or metadata relating to the media items; in some embodiments, the one or more server data module(s) 330 include:
   a media content database 332 for storing media items; and
   a metadata database 334 for storing metadata relating to the media items, including a genre associated with the respective media items.

In some embodiments, the media content server 104 includes web or Hypertext Transfer Protocol (HTTP) servers, File Transfer Protocol (FTP) servers, as well as web pages and applications implemented using Common Gateway Interface (CGI) script, PHP Hyper-text Preprocessor (PHP), Active Server Pages (ASP), Hyper Text Markup Language (HTML), Extensible Markup Language (XML), Java, JavaScript, Asynchronous Javascript and XML (AJAX), XHP, Javelin, Wireless Universal Resource File (WURFL), and the like.

Each of the above identified modules stored in memory 212 and 306 corresponds to a set of instructions for performing a function described herein. The above identified modules or programs (i.e., sets of instructions) need not be implemented as separate software programs, procedures, or modules, and thus various subsets of these modules may be combined or otherwise re-arranged in various embodiments. In some embodiments, memory 212 and 306 optionally store a subset or superset of the respective modules and data structures identified above. Furthermore, memory 212 and 306 optionally store additional modules and data structures not described above.

Although FIG. 3 illustrates the media content server 104 in accordance with some embodiments, FIG. 3 is intended more as a functional description of the various features that may be present in one or more media content servers than as a structural schematic of the embodiments described herein. In practice, and as recognized by those of ordinary skill in the art, items shown separately could be combined and some items could be separated. For example, some items shown separately in FIG. 3 could be implemented on single servers and single items could be implemented by one or more servers. In some embodiments, media content database 332 and/or metadata database 334 are stored on devices (e.g., CDN 106) that are accessed by media content server 104. The actual number of servers used to implement the media content server 104, and how features are allocated among them, will vary from one implementation to another and, optionally, depends in part on the amount of data traffic that the server system handles during peak usage periods as well as during average usage periods.

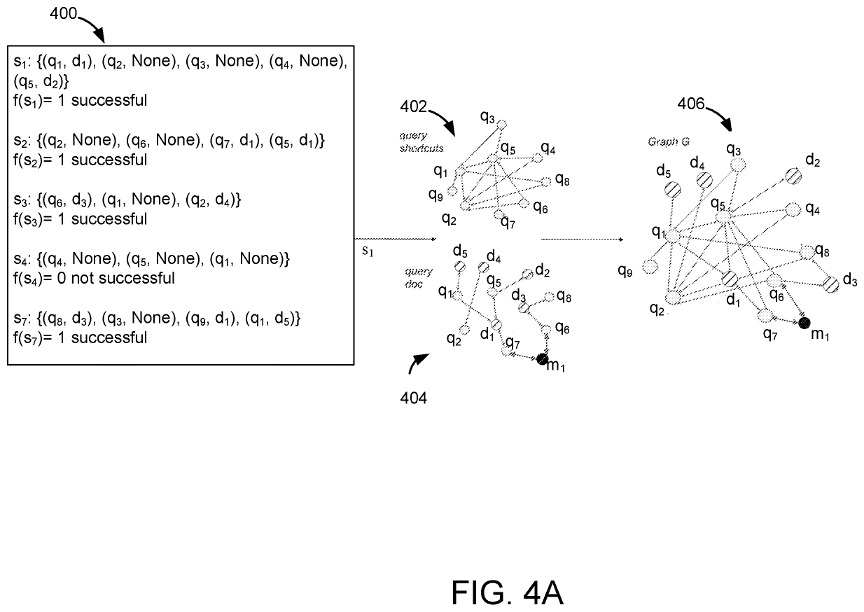

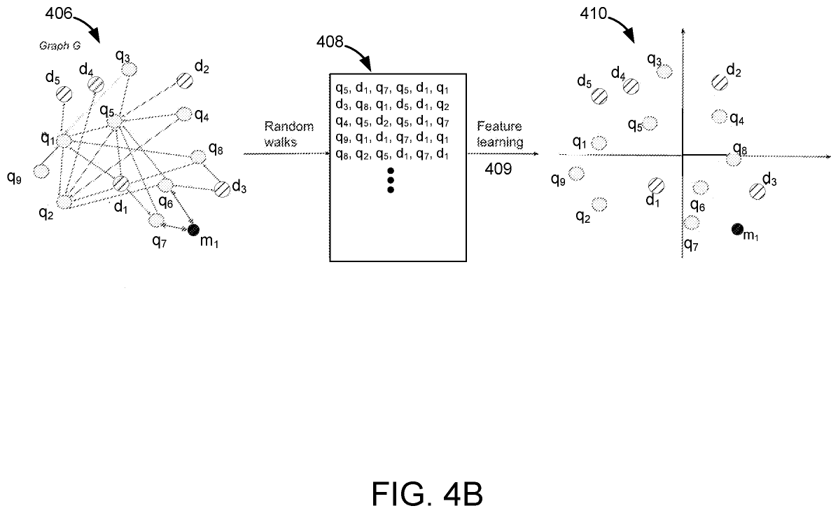

FIGS. 4A-4B are block diagrams illustrating a process of generating a graph that is then converted to vectors in a vector space. FIG. 4A illustrates generating graph 406 using a plurality of search sessions, s₁ through s₇, from search history 400. In some embodiments, the plurality of search sessions are obtained from a search history of one or more users of the media-providing service (e.g., the search sessions include search queries input by the one or more users).

In some embodiments, a respective search session of the plurality of search sessions comprises one or more search queries (q) that are input (e.g., via text or voice) by a respective user (e.g., or a plurality of users) of the media-providing service. In some embodiments, a search session includes a plurality of related search queries that are grouped within the same search session based on a heuristic. For example, the heuristic identifies one or more search queries that are entered within a threshold amount of time of one another (e.g., less than 30 seconds between receiving a next search query, or without listening to a threshold amount of a media item after entering the search query), how much one or more search queries (e.g., successive search queries) change over time (e.g., changing spelling, using different terms related to a same topic, etc.), and/or other features of the one or more search queries, and identifying a group of the search queries as belonging to a same session. In some embodiments, the system determines a search session using a heuristic to identify whether the user intended to update the query for a same search intent (e.g., each search session corresponds to a same search intent). In some embodiments, a successful query (as discussed below) ends a search session. Thus, in some circumstances, a “search session” can be thought of as a series of refined search queries that are entered by a user in order to find what the user is looking for.

In some embodiments, the search history 400 indicates, for each search session, a query, q, input by the user, and whether a document, d, (e.g., a media item, such as a track, an album, a playlist, a podcast, an audiobook, or other item) was selected and/or consumed from the search results provided for the respective search query, q. As such, for each search session of search history 400, a query of the search session is associated with a document selected (and/or consumed) from the search results (e.g., that was clicked on) or None (e.g., if no document was clicked on). For example, in the first search session, s₁, document d₁ is selected (and/or consumed) from search query q₁, no document (None) is selected from search query q₂, no document (None) is selected from search query q₃, no document (None) is selected from search query q₄, and document d₂ is selected from search query q₅ (e.g., the final query in the search session s₁).

In some embodiments, each of the identified search sessions is determined to be a successful or unsuccessful search session. For example, the search session is determined to be successful (e.g., f(s₁)=1 successful) in accordance with a determination that the user consumed a media item (e.g., a document) from the search results provided in response to a query input in the search session, and is determined to be unsuccessful if the user does not select any documents from any of the queries in the search session (e.g., f(s₄)=0 not successful). In some embodiments, e.g., in which the documents are media content items, a user is considered to have “consumed” a media content item after listening to a threshold amount of the media content item.

In some embodiments, to generate graph 406, the system identifies query shortcuts 402 and query-document relationships 404. In some embodiments, query shortcuts 402 include a plurality of nodes, each node corresponding to a query from one or more of the successful search sessions in search history 400. In some embodiments, the query shortcuts 402 are represented by connecting the nodes via unidirectional edges. For example, for a successful search session, each query in the search session that is entered prior to the last query in the search session (e.g., an unsuccessful query), is directed to (e.g., connected to) the last query of the search session (e.g., the successful query). For example, in graph of query shortcuts 402, for the first successful search session, s₁, each query (q₁, q₂, q₃ and q₄) is directed to the last query, q₅, of the search session s₁. As such, each query prior to the last query q₅ in the search session is connected via a unidirectional edge as a shortcut for the last query q₅. The unidirectional edges in these circumstances signify that it is logical to allow movement (in the random walk strategy described below) from an unsuccessful query to a successful query, but not the other way around. Using unidirectional edges for query shortcuts 402 thus improves the quality of the resulting vectors (generated as described below).

In some embodiments, query-document relationships 404 include a plurality of query nodes and a plurality of document nodes. In some embodiments, respective query-document node pairs are connected via bidirectional edges. For example, for each query in which a document is selected (e.g., clicked on), the query is connected to the selected document. The bidirectional edges in these circumstances signify that it is logical to allow movement (in the random walk strategy described below) from a document to a query or from a query to a document. Using bidirectional edges for query-document relationships 404 thus improves the quality of the resulting vectors (generated as described below).

In some embodiments, a selected document is associated with metadata (e.g., a topic, descriptor, genre, artist, playlist, or other information) and one or more metadata nodes corresponding to the metadata are connected to the document via bidirectional edges. In some embodiments, the one or more metadata nodes for a selected document are optionally connected to a respective query associated with the selected query. For example, m₁ represents a metadata note that corresponds to metadata associated with one or more documents, including d₁ and d₃. In some embodiments, the query-document relationships 404 include connections (e.g., bidirectional edges) between the queries that are connected to the documents associated with the metadata. As such, metadata node mi is connected to queries q₆ and q₇. It will be understood that various metadata nodes may be connected to a single document, or to a plurality of documents (e.g., and/or a plurality of queries corresponding to the documents).

In some embodiments, graph 406 is generated by combining the query-document relationships 404 with query shortcuts 402. As such, graph 406 includes bidirectional and unidirectional edges that represent relationships between nodes that correspond to queries, documents, and/or metadata.

FIG. 4B illustrates converting the graph 406 to a vector space 410. In some embodiments, graph 406 is converted to vector space 410 by performing random walks to generate sequences 408 of neighboring nodes. Although any number of random walk strategies are contemplated within the embodiments of the present disclosure, such random walk strategies generally include selecting a first node (e.g., at random) to begin the random walk and randomly selecting an allowable transition to a second node. A random walk starting at the first node is then used to generate a vector for the first node as described below. The allowable transitions are provided by the edges and the corresponding directionality. For example, a transition from the first node to the second node is allowable if there is a unidirectional edge from the first node to the second node, or if there is a bidirectional edge between the first node and the second node. In some embodiments, a respective node will have a plurality of possible transitions (e.g., edges connecting the respective node to another respective node), and a uniform transition probability is assigned for the plurality of possible transitions (e.g., a transition is selected at random). For a given random walk, a number of steps are performed in this manner (e.g., moving from the first node to the second node, and then from the second node to a third node in an analogous manner, and so on), which generates a respective sequence 408 (e.g., a row in sequences 408). A plurality of random walks is performed (e.g., 1000 or 10,000 random walks) in an analogous manner, thus populating the rows of sequences 408.

In some embodiments a graph neural network (GNN), using feature learning 409, takes, as an input, sequences 408 (e.g., the random walks through the graph 406) and outputs vectors in a vector space 410, including vectors representing at least a portion of the nodes from graph 406 (e.g., including query nodes, document nodes, and/or metadata nodes).

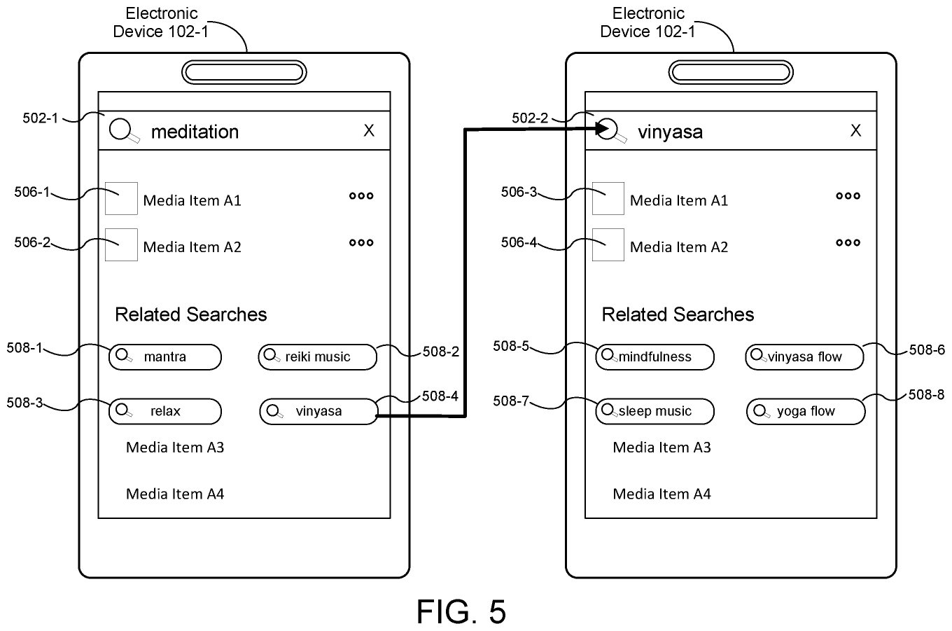

In some embodiments, the vector space 410 is used to identify query recommendations (e.g., using a cosine similarity). For example, a scoring function is used to rank candidates and generate a list of query recommendations based on the vector space 410, as described with reference to FIG. 5.

FIG. 5 illustrates a user interface for displaying a plurality of recommended search queries (e.g., related searches) in addition to displaying search results for a query. In some embodiments, electronic device 102-1 displays a search user interface, including a search bar that includes a user-input search query (e.g., input via voice or text). For example, search query 502-1 recites “meditation.” In some embodiments, the user interface displays search results corresponding to search query 502-1, including media items 506-1 and 506-2 (e.g., or other documents that match search criteria indicated by search query 502-1). In some embodiments, the user interface displays a plurality of “Related Searches,” which represent recommended queries selected using the vector space 410. For example, “Related Searches” includes queries 508-1, 508-2, 508-3 and 508-4, each query corresponding to a selectable user interface element (e.g., a button and/or link) that when selected, replaces the user-input search query with the selected query.

In some embodiments, Related Searches includes queries 508-1, 508-2, 508-3 and 508-4, which are selected and/or sorted (e.g., in order) using a scoring function applied to vector space 410. In some embodiments, the scoring function determines an order of recommended search queries and/or search results according to the nodes that are closest to the query input by the user. For example, if the user inputs a search query 502-1 of “meditation” (e.g., corresponding to q₄), the system identifies a closest neighbor node (e.g., according to cosine distance) to determine that q₈ is the closest node, whereby q₈ corresponds to a search query 508-1 of “mantra” (e.g., the first suggested query in a list of suggested queries displayed in FIG. 5). In some embodiments, the recommended search queries (e.g., displayed under “Related Searches”) includes queries previously input by a user (e.g., q nodes in the vector space), as well as one or more particular documents (e.g., d nodes in the vector space), and/or one or more metadata (e.g., a topic or a genre) (e.g., m nodes in the vector space). As such, the nodes that are closest to the user's input query are presented (e.g., displayed in a search user interface) to the user as a suggested query in Related Searches such that the user is enabled to select at least one of the suggested queries to use as the new search query.

For example, in FIG. 5, the user selects, query 508-4 “vinyasa” (e.g., which corresponds to a neighbor node to the query “meditation” in the vector space), and the search query 502-2 is updated to “vinyasa.” In some embodiments, Related Searches (e.g., suggested queries 508-5, 508-6, 508-7, and 508-8) are then provided based on the node corresponding to “vinyasa” in the vector space. In some embodiments, each of queries 508-5, 508-6, 508-7, and 508-8 are displayed as user-selectable user interface elements (e.g., that the user is enabled to select to update the search query 502-2 to the selected suggested query). In addition, search results 506-3 and 506-4 (e.g., media items) that match search criteria indicated by “vinyasa” are provided in the user interface of electronic device 102-1.

In some embodiments, the system determines whether user-entered queries are complete or incomplete queries. The system filters the search results, including the Related Searches, so as to only provide complete queries as suggestions in Related Searches. For example, incomplete queries are not displayed for the user as suggestions.

Accordingly, the system uses vector space 410, which is generated based on search history 400, to improve query recommendations for the user.

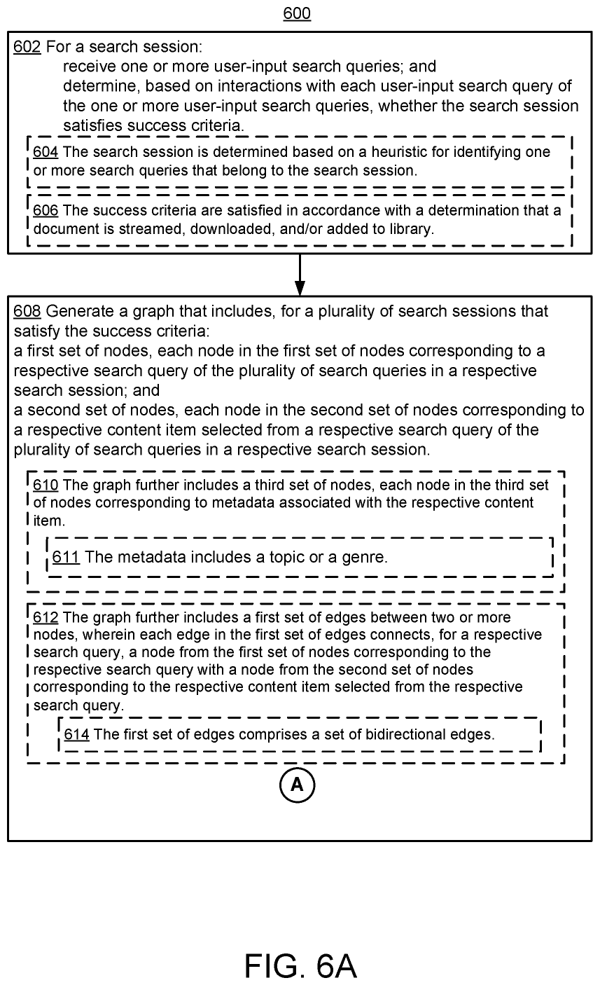

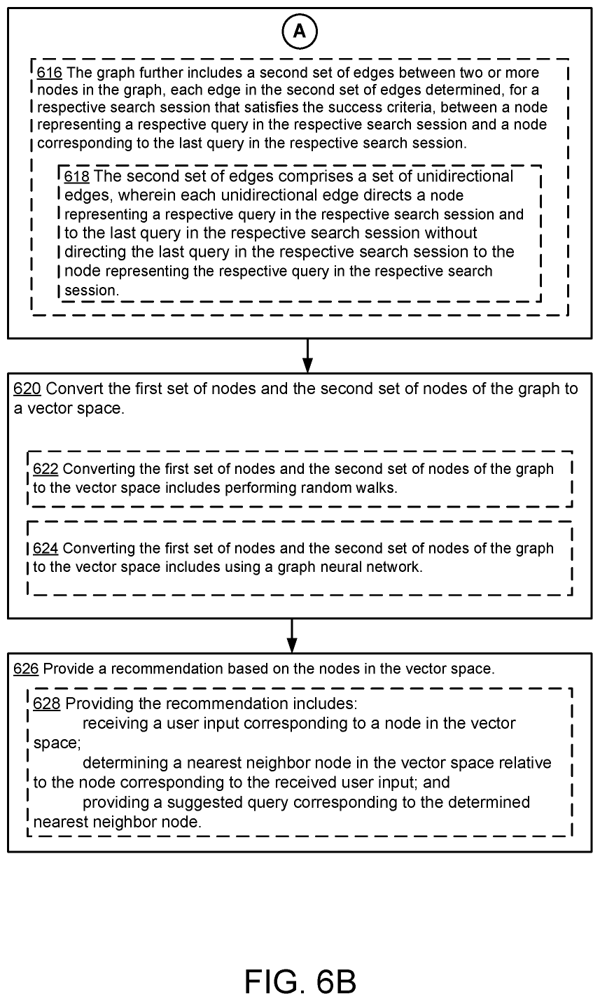

FIGS. 6A-6B are flow diagrams illustrating a method 600 of suggesting search queries, in accordance with some embodiments. Method 600 may be performed at an electronic device (e.g., media content server 104 and/or electronic device(s) 102) having one or more processors and memory storing instructions for execution by the one or more processors. In some embodiments, the method 600 is performed by executing instructions stored in the memory (e.g., memory 212, FIG. 2, memory 306, FIG. 3) of the electronic device. In some embodiments, the method 600 is performed by a combination of the server system (e.g., including media content server 104 and CDN 106) and a client device.

Referring now to FIG. 6A, in performing the method 600, the electronic device, for a search session: receives (602) one or more user-input search queries (e.g., optionally including partial search queries and/or complete search queries) and determines, based on interactions with each user-input search query of the one or more user-input search queries, whether the search session satisfies success criteria. For example, as described with reference to FIG. 4A, search history 400 includes search sessions (e.g., each search session including one or more queries input by a user), whereby a search session is determined as successful or unsuccessful.

In some embodiments, the search session is determined (604) based on a heuristic for identifying one or more search queries that belong to the search session (e.g., the heuristic based on how much queries change, an amount of time between searches, or other features), as described with reference to FIG. 4A. For example, a set of queries are grouped within a same search session in accordance with the heuristic determining a same user intent for each query.

In some embodiments, the success criteria are satisfied in accordance with a determination (606) that a document (e.g., media item) is streamed, downloaded, and/or added to library (e.g., the user has engaged with the document). For example, as described in FIG. 4A, each search session is labeled as successful or unsuccessful based on a user's interaction with the last query in the search session. In some embodiments, if the user interacts with a document (e.g., search result) provided based on a last query in the search session, such as by downloading or streaming at least a threshold amount of (e.g., at least 20 seconds of, at least 1 minute of, or at least a percentage of) the document (e.g., media item), the search session that includes the last query is considered a successful search session. In some embodiments, if the user does not interact with any of the documents (e.g., search results) that are provided based on the last query (e.g., or any other query in the search session), then the search session is determined as unsuccessful (e.g., search session 4 in FIG. 4A is not successful).

The electronic device generates (608) a graph that includes, for a plurality of search sessions that satisfy the success criteria: a first set of nodes, each node in the first set of nodes corresponding to a respective search query of the plurality of search queries in a respective search session; and a second set of nodes, each node in the second set of nodes corresponding to a respective content item selected from a respective search query of the plurality of search queries in a respective search session. In some embodiments, the second set of nodes are populated based on the user consuming the respective content item. For example, the success criteria for the search query comprise criteria that are met in accordance with a determination that a respective content item is consumed. For example, graph 406 (FIG. 4A) includes nodes for queries (q) and documents (d) based on the query shortcuts 402 and query-document relationships 404 determined from the search sessions in the search history 400. For example, the documents represent the documents selected from a list of a result set of documents (e.g., search results) that are provided to the user in response to a respective search query.

In some embodiments, the graph further includes (610) a third set of nodes, each node in the third set of nodes corresponding to metadata associated with the respective content item. For example, the query-document relationships 404 optionally include additional nodes representing metadata for respective documents. In some embodiments, edges connect the metadata nodes with the respective content item and/or query nodes associated with the metadata.

In some embodiments, the metadata includes (611) a topic or a genre. In some embodiments, the metadata is stored in a table (e.g., a lookup table) in association with one or more documents (e.g., media content items). For example, different types of documents are stored with different metadata (e.g., a track is stored with metadata such as an album, artist, genre, release year, or other metadata for the track, and a podcast is stored with metadata such as a guest speaker, topic, publisher, or other metadata for the podcast). In some embodiments, as described with reference to FIG. 4A, metadata overlaps across multiple documents (e.g., and multiple queries). For example, two documents share a genre (e.g., or topic) in the metadata for each document. In some embodiments, each metadata node corresponds to different information (e.g., for a track, a first metadata node exists for the genre and a second metadata node exists for an artist name). In some embodiments, a metadata node is based on a combination of information (e.g., representing both genre and artist name).

In some embodiments, the graph further includes (612) a first set of edges between two or more nodes, wherein each edge in the first set of edges connects, for a respective search query, a node from the first set of nodes corresponding to the respective search query with a node from the second set of nodes corresponding to the respective content item selected from the respective search query. For example, as described with reference to FIG. 4A, query-document relationships 404 are determined between query nodes and document nodes.

In some embodiments, the first set of edges comprises (614) a set of bidirectional edges (e.g., each edge is given an independent orientation at each end, such that each node is directed to the other nodes, and vice-versa, via the bidirectional edge). In some embodiments, a metadata node is also connected to the associated query and/or document nodes via bidirectional edges, as described with reference to FIG. 4A.

In some embodiments, the graph further includes (616) a second set of edges between two or more nodes in the graph, each edge in the second set of edges determined, for a respective search session that satisfies the success criteria, between a node representing a respective query in the respective search session and a node corresponding to the last query in the respective search session. For example, as described with reference to FIG. 4A, edges, or “shortcuts” (e.g., query shortcuts 402) are determined for a successful search session, whereby the successful query for the search session (e.g., the last query) is connected, via an edge, to the other queries in the search session)

In some embodiments, the second set of edges comprises (618) a set of unidirectional edges, wherein each unidirectional edge directs a node representing a respective query in the respective search session and to the last query in the respective search session without directing the last query in the respective search session to the node representing the respective query in the respective search session.

The electronic device converts (620) the first set of nodes and the second set of nodes of the graph to a vector space (e.g., to respective vectors in the vector space). For example, as described with reference to FIG. 4B, graph 406 is converted to vectors in vector space 410.

In some embodiments, converting the first set of nodes and the second set of nodes of the graph to the vector space includes (622) performing random walks (e.g., as described with reference to FIG. 4B).

In some embodiments, converting the first set of nodes and the second set of nodes of the graph to the vector space includes (624) using a graph neural network (GNN). For example, one or more features are input to the GNN to create the vectors in the vector space 410.

The electronic device provides (626) a recommendation (e.g., a recommended query) based on the nodes (e.g., vectors) in the vector space. For example, as described with reference to FIG. 5, one or more query recommendations are provided (e.g., displayed in a search user interface).

In some embodiments, providing the recommendation includes (628): receiving a user input corresponding to a node (e.g., vector) in the vector space; determining a nearest neighbor node in the vector space relative to the node corresponding to the received user input; and providing (e.g., in a display) a suggested query corresponding to the determined nearest neighbor node (e.g., a user query corresponds to a first node, and the system recommends a second node as a search term in accordance with the second node being closest to the first node in the vector space). For example, as described with reference to FIG. 4B, the user inputs a query corresponding to q₄, and based on the cosine distance between the nodes in vector space 410, the device provides recommendations of the nearest neighbor nodes (e.g., or other similar nodes selected using another similarity function), optionally ranked based on similarity to the user input query corresponding to the q₄ node. In some embodiments, a nearest neighbor node, such as q₅, is provided (e.g., displayed) in the search user interface as a recommended query. Note that the term “nodes” when used in reference to vector space 410 refers to vectors in the vector space 410 that are the result of converting nodes into the vector space 410.

Although FIGS. 6A-6B illustrate a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

The foregoing description, for purpose of explanation, has been described with reference to specific embodiments. However, the illustrative discussions above are not intended to be exhaustive or to limit the embodiments to the precise forms disclosed. Many modifications and variations are possible in view of the above teachings. The embodiments were chosen and described in order to best explain the principles and their practical applications, to thereby enable others skilled in the art to best utilize the embodiments and various embodiments with various modifications as are suited to the particular use contemplated.

1. A method of suggesting search queries, including:
at an electronic device:
for a search session:
receiving one or more user-input search queries; and
determining, based on interactions with each user-input search query of the one or more user-input search queries, whether the search session satisfies success criteria;
generating a graph that includes, for a plurality of search sessions that satisfy the success criteria:
a first set of nodes, each node in the first set of nodes corresponding to a respective search query of the one or more user-input search queries in a respective search session; and
a second set of nodes, each node in the second set of nodes corresponding to a respective content item selected from a respective search query of the one or more user-input search queries in a respective search session; and
converting the first set of nodes and the second set of nodes of the graph to vectors in a vector space, including vectors representing at least a subset of the first set of nodes and the second set of nodes; and
providing a recommendation based on the vectors in the vector space.

2. The method of claim 1, wherein the search session is determined based on a heuristic for identifying one or more search queries that belong to the search session.

3. The method of claim 1, wherein the graph further includes a first set of edges between two or more nodes, wherein each edge in the first set of edges connects, for a respective search query, a node from the first set of nodes corresponding to the respective search query with a node from the second set of nodes corresponding to the respective content item selected from the respective search query.

4. The method of claim 3, wherein the first set of edges comprises a set of bidirectional edges.

5. The method of claim 1, wherein the graph further includes a second set of edges between two or more nodes in the graph, each edge in the second set of edges determined, for a respective search session that satisfies the success criteria, between a node representing a respective query in the respective search session and a node corresponding to the last query in the respective search session.

6. The method of claim 5, wherein the second set of edges comprises a set of unidirectional edges, wherein each unidirectional edge directs a node representing a respective query in the respective search session and to the last query in the respective search session without directing the last query in the respective search session to the node representing the respective query in the respective search session.

7. The method of claim 1, wherein providing the recommendation includes:
receiving a user input corresponding to a vector in the vector space;
determining a nearest neighbor vector in the vector space relative to the vector corresponding to the received user input; and
providing a suggested query corresponding to the determined nearest neighbor vector.

8. The method of claim 1, wherein the graph further includes a third set of nodes, each node in the third set of nodes corresponding to metadata associated with the respective content item.

9. The method of claim 8, wherein the metadata includes a topic or a genre.

10. The method of claim 1, wherein converting the first set of nodes and the second set of nodes of the graph to the vectors in the vector space includes performing random walks.

11. The method of claim 1, wherein converting the first set of nodes and the second set of nodes of the graph to the vectors in the vector space includes using a graph neural network.

12. The method of claim 1, wherein the success criteria are satisfied in accordance with a determination that a document is streamed, downloaded, and/or added to a library.

13. An electronic device, comprising:
one or more processors; and
memory storing one or more programs, the one or more programs including instructions for:
for a search session:
receiving one or more user-input search queries; and
determining, based on interactions with each user-input search query of the one or more user-input search queries, whether the search session satisfies success criteria;
generating a graph that includes, for a plurality of search sessions that satisfy the success criteria:
a first set of nodes, each node in the first set of nodes corresponding to a respective search query of the one or more user-input search queries in a respective search session; and
a second set of nodes, each node in the second set of nodes corresponding to a respective content item selected from a respective search query of the one or more user-input search queries in a respective search session; and
converting the first set of nodes and the second set of nodes of the graph to vectors in a vector space, including vectors representing at least a subset of the first set of nodes and the second set of nodes; and
providing a recommendation based on the vectors in the vector space.

14. A non-transitory computer-readable storage medium storing one or more programs for execution by an electronic device with one or more processors, the one or more programs comprising instructions for:
for a search session:
receiving one or more user-input search queries; and
determining, based on interactions with each user-input search query of the one or more user-input search queries, whether the search session satisfies success criteria;
generating a graph that includes, for a plurality of search sessions that satisfy the success criteria:
a first set of nodes, each node in the first set of nodes corresponding to a respective search query of the one or more user-input search queries in a respective search session; and
a second set of nodes, each node in the second set of nodes corresponding to a respective content item selected from a respective search query of the one or more user-input search queries in a respective search session; and
converting the first set of nodes and the second set of nodes of the graph to vectors in a vector space, including vectors representing at least a subset of the first set of nodes and the second set of nodes; and
providing a recommendation based on the vectors in the vector space.

15. The electronic device of claim 13, wherein the search session is determined based on a heuristic for identifying one or more search queries that belong to the search session.

16. The electronic device of claim 13, wherein the graph further includes a first set of edges between two or more nodes, wherein each edge in the first set of edges connects, for a respective search query, a node from the first set of nodes corresponding to the respective search query with a node from the second set of nodes corresponding to the respective content item selected from the respective search query.

17. The electronic device of claim 16, wherein the first set of edges comprises a set of bidirectional edges.

18. The electronic device of claim 13, wherein the graph further includes a second set of edges between two or more nodes in the graph, each edge in the second set of edges determined, for a respective search session that satisfies the success criteria, between a node representing a respective query in the respective search session and a node corresponding to the last query in the respective search session.

19. The electronic device of claim 18, wherein the second set of edges comprises a set of unidirectional edges, wherein each unidirectional edge directs a node representing a respective query in the respective search session and to the last query in the respective search session without directing the last query in the respective search session to the node representing the respective query in the respective search session.

20. The electronic device of claim 13, wherein providing the recommendation includes:
receiving a user input corresponding to a vector in the vector space;
determining a nearest neighbor vector in the vector space relative to the vector corresponding to the received user input; and
providing a suggested query corresponding to the determined nearest neighbor vector.
